(19) United States
(12) Patent Application Publication
(10) Pub. No.: US 2010/0215180 A1
(43) Pub. Date: Aug. 26, 2010

(54) Replacement of keys

(75) Inventors: Yaacov Belenky, Maaleh Adumim (IL); Yaakov Jordan Levy, Maaleh Adumim (IL); Ittael Fraenkel, Nof Ayalon (IL)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: NDS LIMITED, STAINES , MIDDLESEX (GB)

(21) Appl. No.: 12/733,233

(22) PCT Filed: Jun. 11, 2008
(86) PCT No.: PCT/IB2008/052300

§ 371 Date: Mar. 19, 2010

(30) Foreign Application Priority Data
Sep. 25, 2007 (IL) 186287

(51) Int. Cl. H04L 9/08; G06F 12/14

(52) U.S. Cl. 380/278; 713/193; 380/277

(57) ABSTRACT

A method and system for assigning a key to a device, the method including providing a device having a processor ID (CID) and an associated processor key (CK) and including a memory, at a first time, storing a personalization data ID (PDID) and associated personalization data (PD) in the memory, at a later time, sending the CID and the PDID to a security provider and receiving an activation value (AV) back from the security provider, the activation value AV being based, at least in part, on the CK and a personalization data key (PDK) associated with the PDID and the PD, computing, in the device, a result, based, at least in part, on the CK and the activation value, the result being produced by applying a first function g to the CK and the AV, such that the result=g(CK, AV), and storing the result in the memory, wherein a second function ƒ is used to compute the value of AV, such that AV=ƒ(CK, PDK), and ƒ includes an inverse function of function g, such that g(CK, ƒ(CK, PDK))=PDK, thereby assigning the personalization data key PDK to the device. Related methods and hardware are also described.

### FIELD OF THE INVENTION

The present invention relates to methods and systems for ensuring security of devices such as, for example, content rendering devices, and more specifically, to methods and systems for replacing keys in such devices.

### BACKGROUND OF THE INVENTION

A secure chip integrated into a secure device comprising a secret, for example, and without limiting the generality of the foregoing, a content rendering device, typically requires some sort of data uniquely identifying that particular chip. Typically, such a chip comprises a secure kernel, the secure kernel typically operative to receive an input of some appropriate data from the content rendering device (hereinafter referred to as “the device”), the input typically ensuring that the device is legitimately licensed to access security functions available only once the security kernel is activated. Typically, if the kernel is not activated, the device will, at least, be unable to render certain types of protected content.

The case of a secure chip comprising a secure kernel is presented by way of example only and is not meant to be limiting.

The term “chip”, as used in the present specification and claims, refers to an integrated circuit, typically comprising a plurality of processors and a plurality of appropriate hardware blocks. It is appreciated that an appropriate software implementation of the security kernel may also be implemented.

The term “render”, as used in the present specification and claims refers to making content palpable to at least one human sense.

Examples of content rendering devices referred to in the present specification and claims include, but are not limited to, MP3 or MP4 playing devices, set top boxes (STBs), and Personal Video Recorders (PVRs).

One non-limiting example of a secure kernel is a secure kernel comprised in an SVP compliant chip such as, for example, the commercially-available Broadcom BRCM7401 chips. SVP is an open technology specification for digital content protection. Details regarding SVP, including SVP compliant secure chips, are available on the Internet at www.svpalliance.org.

The aforementioned input to the secure kernel, hereinafter referred to as Personalization Data (PD), is typically encrypted, digitally signed, or both encrypted and digitally signed. Alternatively, PD may only be partially encrypted, partially digitally signed, or both partially encrypted and partially digitally signed.

Typically, in the art, a unique PD is assigned to each chip. During device production, a unique chip ID (CID) is read from the chip, and a corresponding PD is found in a database. The PD is typically burned into device non-volatile memory.

Typically, the database is provided by a security provider, such as, and without limiting the generality of the foregoing, a conditional access provider or a content protection provider. Typically, the database is huge, possibly comprising tens of millions of PDs and CIDs.

### SUMMARY OF THE INVENTION

With reference to the above discussion, the inventors of the present invention believe that, because the security provider needs to send the database to the device manufacturer, due to the size of the database, there are logistical problems, as well as a potential for security problems resulting from the need to send the database to the device manufacturer.

The present invention seeks to provide an improved method of replacing keys within a content rendering device, thereby enabling activation of a security kernel, while minimizing logistical and security problems involved in transferring potentially huge databases of secure data.

There is thus provided in accordance with an embodiment of the present invention a method for assigning a key to a device, the method including providing a device having a processor ID (CID) and an associated processor key (CK) and including a memory, at a first time, storing a personalization data ID (PDID) and associated personalization data (PD) in the memory, at a later time, sending the CID and the PDID to a security provider and receiving an activation value (AV) back from the security provider, the activation value AV being based, at least in part, on the CK and a personalization data key (PDK) associated with the PDID and the PD, computing, in the device, a result, based, at least in part, on the CK and the activation value, the result being produced by applying a first function g to the CK and the AV, such that the result=g(CK, AV), and storing the result in the memory, wherein a second function ƒ is used to compute the value of AV, such that AV=ƒ(CK, PDK), and ƒ includes an inverse function of function g, such that g(CK, ƒ(CK, PDK))=PDK, thereby assigning the personalization data key PDK to the device.

Further in accordance with an embodiment of the present invention the sending the CID and the PDID to the secret owner is performed by at least one of the device, and a device manufacturer.

Still further in accordance with an embodiment of the present invention the device includes at least one of an integrated circuit, and specialized software.

Additionally in accordance with an embodiment of the present invention the device includes a secure kernel.

Moreover in accordance with an embodiment of the present invention the method also includes the secure chip using PDK for at least one of decryption of at least a part of the PD, and signature validation of at least a part of the PD, thereby enabling use of the PD by the secure chip.

Further in accordance with an embodiment of the present invention, function ƒ includes a cryptographic encryption function and function g includes a cryptographic decryption function.

Still further in accordance with an embodiment of the present invention, function ƒ includes a cryptographic decryption function and function g includes a cryptographic encryption function.

Additionally in accordance with an embodiment of the present invention the cryptographic encryption function includes AES encryption, and the cryptographic decryption function includes AES decryption.

Moreover in accordance with an embodiment of the present invention the cryptographic encryption function includes DES encryption, and the cryptographic decryption function includes DES decryption.

Further in accordance with an embodiment of the present invention the cryptographic encryption function includes 3DES encryption, and the cryptographic decryption function includes 3DES decryption.

Still further in accordance with an embodiment of the present invention the cryptographic encryption function includes SERPENT encryption, and the cryptographic decryption function includes SERPENT decryption.

Additionally in accordance with an embodiment of the present invention the cryptographic encryption function includes IDEA encryption, and the cryptographic decryption function includes IDEA decryption.

Moreover in accordance with an embodiment of the present invention the AV is digitally signed.

Further in accordance with an embodiment of the present invention the digital signature includes an asymmetric digital signature.

Still further in accordance with an embodiment of the present invention the digital signature includes a symmetric digital signature.

Additionally in accordance with an embodiment of the present invention the function g verifies the correctness of the digital signature.

There is also provided in accordance with a another embodiment of the present invention a system for assigning a key to a device, the system including a device having a processor ID (CID) and an associated processor key (CK) and including a memory, a personalization data ID (PDID) and associated personalization data (PD) being stored in the memory at a first time, apparatus operative to send, at a later time, the CID and the PDID to a security provider and receive an activation value (AV) back from the security provider, the activation value AV being based, at least in part, on the CK and a personalization data key (PDK) associated with the PDID and the PD, a processor included in the device, operative to compute a result, based, at least in part, on the CK and the activation value, the result being produced by applying a first function g to the CK and the AV, such that the result=g(CK, AV), and the result being stored in the memory, wherein a second function ƒ is used to compute the value of AV, such that AV=ƒ(CK, PDK), and ƒincludes an inverse function of function g, such that g(CK, ƒ(CK, PDK))=PDK, thereby assigning the personalization data key PDK to the device.

### BRIEF DESCRIPTION OF THE DRAWINGS

The present invention will be understood and appreciated more fully from the following detailed description, taken in conjunction with the drawings in which:

FIG. 1 is a simplified block diagram illustration of a system for replacing keys constructed and operative in accordance with an embodiment of the present invention;

FIG. 2 is a simplified block diagram illustration of an exemplary method of transferring a database between a security provider and a device manufacturer within the system of FIG. 1;

FIG. 3 is a simplified block diagram illustration of an exemplary method of transferring a database between the device manufacturer and the security provider within the system of FIG. 1;

FIG. 4 is a simplified block diagram illustration of an exemplary database query determining a chip key and an associated personalization data key, the query performed by the security provider within the system of FIG. 1;

FIG. 5 is a simplified block diagram illustration of an exemplary method of delivering a secure kernel activation value to a device within the system of FIG. 1;

FIG. 6 is a simplified block diagram illustration of an exemplary method of delivering a response to the secure kernel activation value from a chip comprised in the device to device memory within the system of FIG. 1;

FIG. 7 is a simplified block diagram illustration of an exemplary method of delivering a personalization data key from the device memory to the chip within the system of FIG. 1; and

FIG. 8 is a simplified flowchart of an exemplary method of operation of the system of FIG. 1.

### DETAILED DESCRIPTION OF AN EMBODIMENT

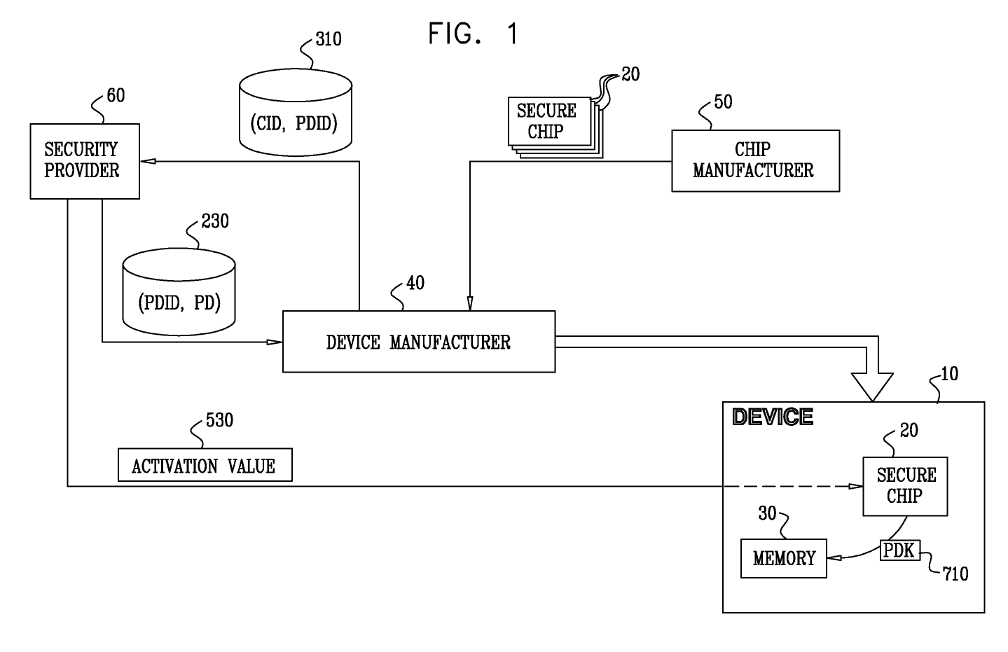

Reference is now made to FIG. 1 which is a simplified block diagram illustration of a system for replacing keys constructed and operative in accordance with an embodiment of the present invention. The system of FIG. 1 comprises a device 10, the device 10 comprising a content rendering device. The device 10 typically comprises at least one of an integrated circuit and specialized software. For ease of depiction, the at least one of an integrated circuit and specialized software are described herein as a secure chip 20. The device 10 further comprises memory 30, the memory 30 typically comprising non-volatile memory. The device 10 further comprises conventional hardware and software.

The system of FIG. 1 further comprises a device manufacturer 40, the device manufacturer 40 typically being a consumer electronics device manufacturer. A chip manufacturer 50 typically manufactures a plurality of secure chips 20. They system of FIG. 1 typically further comprises a security provider 60, the security provider 60 typically comprising a conditional access provider, a content security provider, a DRM system provider, or other appropriate access or rights management provider.

It is appreciated that various subcombinations of the elements of the system of FIG. 1 also comprise an alternative embodiment of the present invention. For example, the device 10 may comprise an alternative embodiment of the present invention.

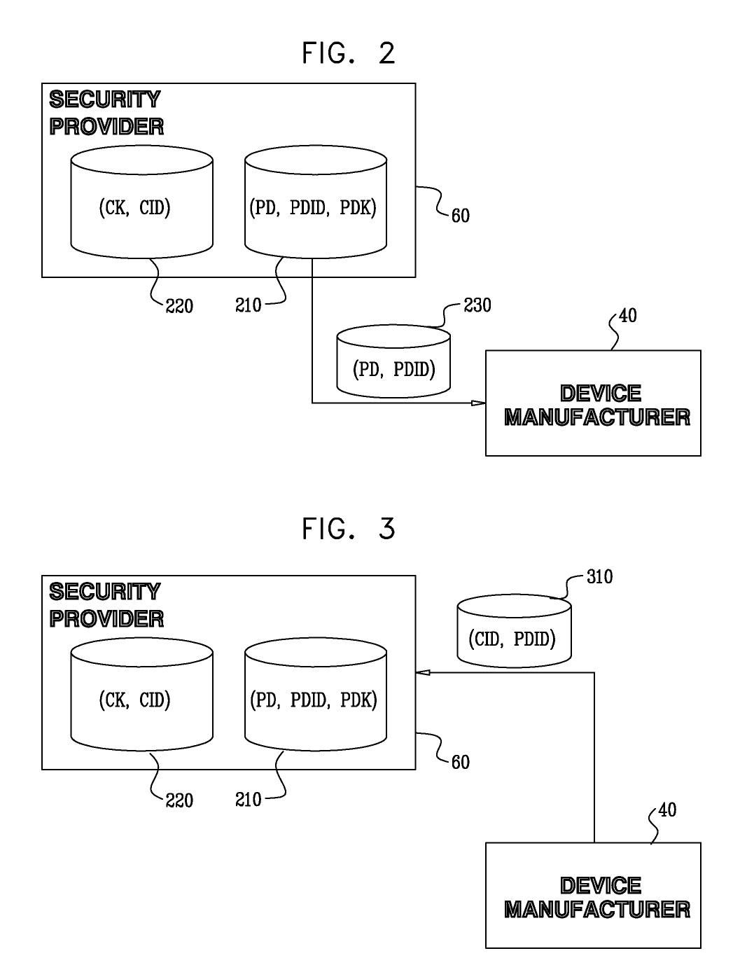

The operation of the system of FIG. 1 is now described, with additional reference to FIGS. 2-7, as noted below. The security provider 60 typically is an owner of a first type of data, at least some of which is secret and uniquely associable with the device 10. The security provider 60 typically also owns a second type of data, which is secret and uniquely associable with the secure chip 20.

The first and the second types of data are discussed with reference to FIG. 2, which is a simplified block diagram illustration of an exemplary method of transferring a database between a security provider and a device manufacturer within the system of FIG. 1. The first type of data, at least some of which is secret and uniquely associable with the device 10 comprises a first database 210 of at least three associated data items: device personalization data (PD); PD ID (PDID); and a unique key (PDK) for use by the device 10 comprising a particular PD. Of the three associated data items, PD and PD ID are not secret, PDK is secret. The PD comprises actual data for use by the device 10. The PDID comprises a unique identifier for the device 10 bearing a particular associated PD.

The second type of data, which is secret and uniquely associable with the secure chip secure chip 20 comprises a second database 220 of at least two associated data items: a unique chip key (CK) for use by the secure chip 20; and a chip ID (CID).

Returning to the discussion of FIG. 1, the security provider 60 sends a third database 230, to the device manufacturer 40. The third database 230 comprises a subset of the first database 210. Specifically, the third database 230 comprises PD and associated PDID. PDK is not included in the third database 230.

The device manufacturer 40 also receives a plurality of secure chips 20 from the chip manufacturer 50. When the device 10 is manufactured, the device manufacturer 40 takes one pair (PD, PDID) from the third database 230, and burns the PD and the PDID into the memory 30, typically the non-volatile memory, of the device 10 under manufacture. Typically, in order to ensure security, each pair of (PD, PDID) comprised in the third database 230 may be used at most once. The device manufacturer 40 also takes one of the plurality of secure chips 20 received from the chip manufacturer 50, and installs the secure chip 20 in the device 10 under manufacture.

Reference is now additionally made to FIG. 3, which is a simplified block diagram illustration of an exemplary method of transferring a database between the device manufacturer and the security provider within the system of FIG. 1. A fourth database 310 comprising a list of which CID and which PDID are associated with each other are reported by the device manufacturer 40 to the security provider 60.

Although the above discussion of FIG. 3 and FIG. 3 itself describes the sending the CID and the PDID to the security provider 60 by the device manufacturer 40, it is appreciated that in certain embodiments of the present invention, the device 10 may in fact itself perform the sending of the CID and the PDID to the security provider 60.

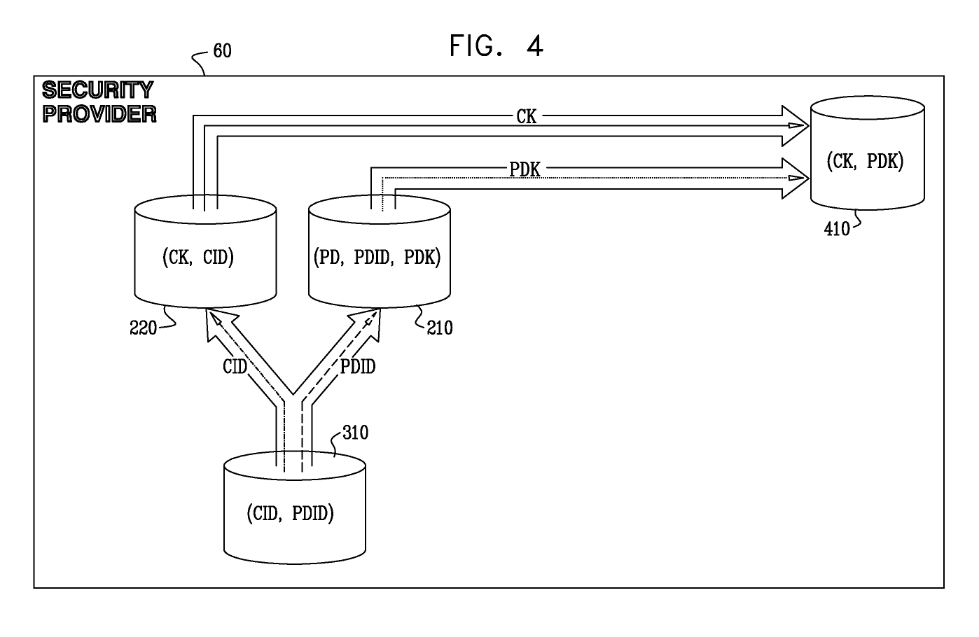

Reference is now additionally made to FIG. 4, which is a simplified block diagram illustration of an exemplary database query determining a chip key and an associated personalization data key, the query performed by the security provider within the system of FIG. 1. In response to receiving the fourth database 310, comprising a list of which CID and which PDID are associated with each other, the security provider 60 queries the first database 210 and the second database 220. Specifically, a PDID and a PDID associated CID from the fourth database 310 are selected from the fourth database 310. The selected PDID is identified in the first database 210, thereby identifying a PDK associated with the selected PDID. Likewise, the selected CID is identified in the second database 220, thereby identifying a CK associated with the selected CID. The query is performed for each CID PDID pair in the fourth database 310. Each identified CK and PDK pair is written in a fifth database 410.

Reference is now made additionally to FIG. 5, which is a simplified block diagram illustration of an exemplary method of delivering a secure kernel activation value 530 (FIG. 1) to a device within the system of FIG. 1. Having identified the (CK, PDK) pair, the security provider 60 computes a value of a function, designated ƒ. The value which results from the computation of ƒ is sent to the device 10 as the activation value (AV) 530, such that AV=ƒ(CK, PDK) 530a.

Reference is now additionally made to FIG. 6, which is a simplified block diagram illustration of an exemplary method of delivering a response to the secure kernel activation value from a chip comprised in the device to device memory within the system of FIG. 1. The device 10 receives AV=ƒ(CK, PDK) 530a. AV=ƒ(CK, PDK) 530a is input into the secure chip 20. The secure chip 20 computes a result of a function designated g. The secure chip retrieves CK, and computes the result=g(CK, AV)=g(CK, ƒ(CK, PDK)) 610. g(CK, ƒ(CK, PDK)) 610 is sent by the secure chip 20 to the memory 30 for storage for possible future use as the PDK 710 (FIG. 1).

It is appreciated that functions f and g are selected so as to be any appropriate functions comprising a pair of inverse functions of each other. For example and without limiting the generality of the foregoing, ƒ may comprise an encryption function, such as AES encryption, and g may comprise a decryption function, such as AES decryption. Any other appropriate encryption and decryption functions may be used, including, but not limited to DES, 3DES, IDEA and SERPENT. Alternatively, ƒ and g may comprise any appropriate function of two arguments, such that ƒ and g are inverses of each other. For example, and without limiting the generality of the foregoing, ƒ(a,b)=b−a, g(a,b)=b+a are two argument functions which are inverses of each other. It is appreciated that addition and subtraction are given by way of example only, as they provide very weak security.

It is appreciated that the security provider security provider 60 (FIG. 5) may optionally concatenate a digital signature to the AV 530 (FIG. 5). In such a case, function g typically, in order to increase security, verifies that the concatenated digital signature is correct. If the concatenated digital signature is incorrect, then the result of function g typically, in order to increase security, remains undefined. The digital signature may be either an asymmetric digital signature, such as, but not limited to an RSA digital signature, or a symmetric digital signature, such as, but not limited to an AES CBC MAC digital signature or, alternatively, a 3DES CBC MAC digital signature.

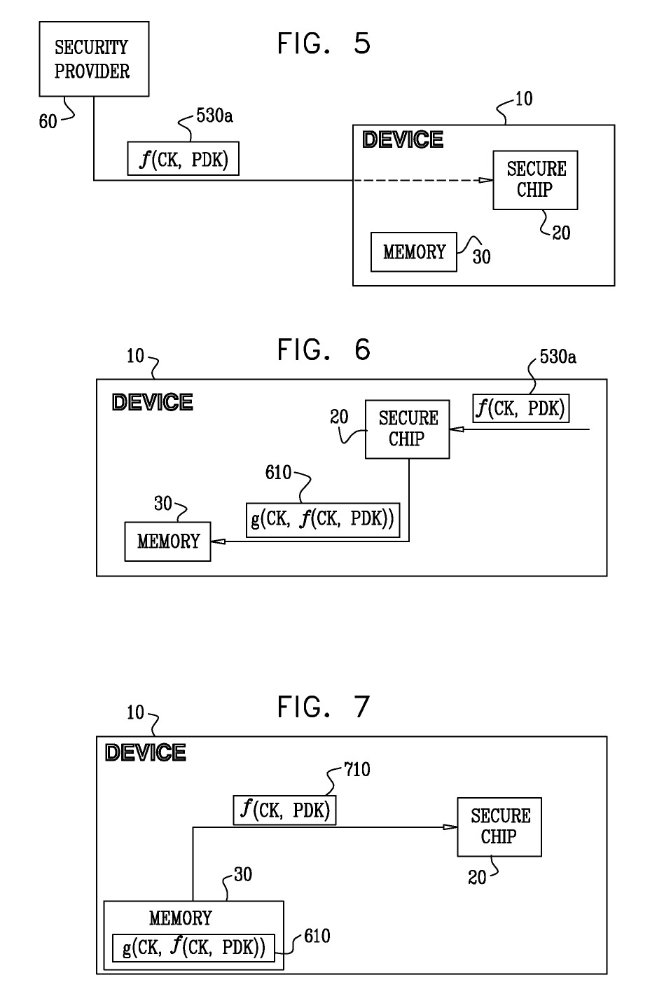

Reference is now made to FIG. 7, which is a simplified block diagram illustration of an exemplary method of delivering a personalization data key from the device memory to the chip within the system of FIG. 1. When it is necessary to activate the secure kernel, software comprised in the device 10 retrieves AV=ƒ(CK, PDK) from the memory 30. The software then sends the AV to the secure chip 20. The secure chip 20 then calculates PDK=g(CK,AV)=g(CK, ƒ(CK, PDK)), and subsequently uses PDK for decryption and signature validation of the PD or at least a part of the PD, thereby enabling use of the PD by the secure chip 20.

It is appreciated that if the device manufacturer 40 either mistakenly or maliciously used a particular PD more than once, the security provider 60 is potentially able to identify such a misuse, by identifying such a multiple usage of the PD in the first database 210. For instance, a PDID associated with the PD may be reported back as being associated with two different CIDs. Once a PD appears to have been used more than once, and the security provider 60 becomes aware that the PD has been used more than once, the security provider 60 is able to take any action deemed appropriate. Such actions may include, but not be limited to refusing to generate the AV 530 (FIG. 1), or potentially, legal action.

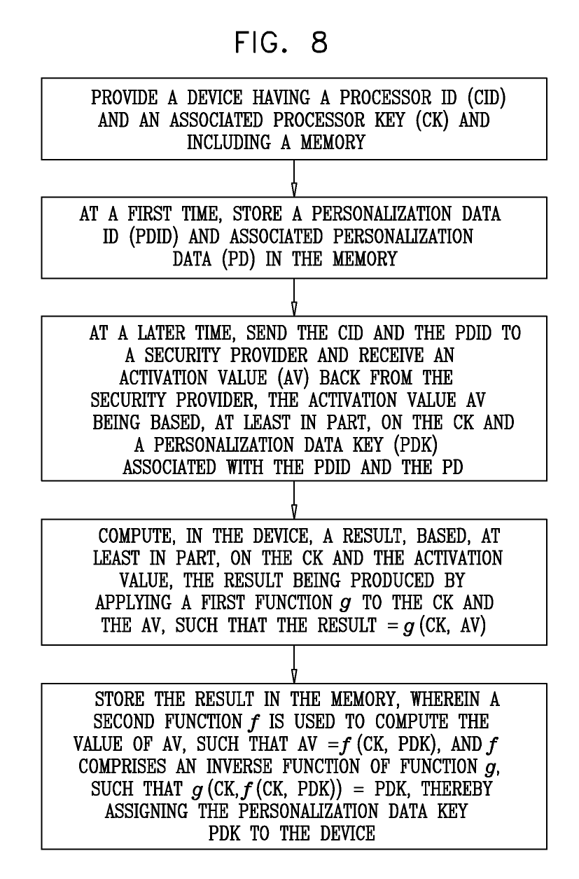

Reference is now made to FIG. 8, which is a simplified flowchart of an exemplary method of operation of the system of FIG. 1. FIG. 8 is believed to be self-explanatory in light of the above discussion.

It is appreciated that software components of the present invention may, if desired, be implemented in ROM (read only memory) form. The software components may, generally, be implemented in hardware, if desired, using conventional techniques.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined only by the claims which follow:

1. A method for assigning a key to a device, the method comprising:
providing a device having a processor ID (CID) and an associated processor key (CK) and comprising a memory;
at a first time, storing a personalization data ID (PDID) and associated personalization data (PD) in the memory;
at a later time, sending the CID and the PDID to a security provider and receiving an activation value (AV) back from the security provider, the activation value AV being based, at least in part, on the CK and a personalization data key (PDK) associated with the PDID and the PD;
computing, in the device, a result, based, at least in part, on the CK and the activation value, the result being produced by applying a first function g to the CK and the AV, such that the result=g(CK, AV); and
storing the result in the memory,
wherein a second function ƒ is used to compute the value of AV, such that AV=ƒ(CK, PDK), and f comprises an inverse function of function g, such that g(CK, ƒ(CK, PDK))=PDK,
thereby assigning the personalization data key PDK to the device.

2. The method according to claim 1, and wherein the sending the CID and the PDID to the secret owner is performed by at least one of: the device; and a device manufacturer.

3. The method according to claim 1 wherein the device comprises at least one of: an integrated circuit; and specialized software.

4. The method according to claim 1 and wherein the device comprises a secure kernel.

5. The method according to claim 4 and also comprising:
the secure chip using PDK for at least one of:
decryption of at least a part of the PD; and
signature validation of at least a part of the PD,
thereby enabling use of the PD by the secure chip.

6. The method according to claim 1 wherein function ƒ comprises a cryptographic encryption function and function g comprises a cryptographic decryption function.

7. The method according to claim 1 wherein function ƒ comprises a cryptographic decryption function and function g comprises a cryptographic encryption function.

8. The method according to claim 6 and wherein the cryptographic encryption function comprises AES encryption, and the cryptographic decryption function comprises AES decryption.

9. The method according to claim 6 and wherein the cryptographic encryption function comprises DES encryption, and the cryptographic decryption function comprises DES decryption.

10. The method according to claim 6 and wherein the cryptographic encryption function comprises 3DES encryption, and the cryptographic decryption function comprises 3DES decryption.

11. The method according to claim 6 and wherein the cryptographic encryption function comprises SERPENT encryption, and the cryptographic decryption function comprises SERPENT decryption.

12. The method according to claim 6 and wherein the cryptographic encryption function comprises IDEA encryption, and the cryptographic decryption function comprises IDEA decryption.

13. The method according to claim 1 and wherein the AV is digitally signed.

14. The method according to claim 13 and wherein the digital signature comprises an asymmetric digital signature.

15. The method according to claim 13 and wherein the digital signature comprises a symmetric digital signature.

16. The method according to claim 13 and wherein the function g verifies the correctness of the digital signature.

17. A system for assigning a key to a device, the system comprising:
a device having a processor ID (CID) and an associated processor key (CK) and comprising a memory;
a personalization data ID (PDID) and associated personalization data (PD) being stored in the memory at a first time;
apparatus operative to send, at a later time, the CID and the PDID to a security provider and receive an activation value (AV) back from the security provider, the activation value AV being based, at least in part, on the CK and a personalization data key (PDK) associated with the PDID and the PD;
a processor comprised in the device, operative to compute a result, based, at least in part, on the CK and the activation value, the result being produced by applying a first function g to the CK and the AV, such that the result=g(CK, AV); and
the result being stored in the memory,
wherein a second function ƒ is used to compute the value of AV, such that AV=ƒ(CK, PDK), and ƒ comprises an inverse function of function g, such that g(CK, ƒ(CK, PDK))=PDK,
thereby assigning the personalization data key PDK to the device.

18. A system for assigning a key to a device, the system comprising:
means for providing a device having a processor ID (CID) and an associated processor key (CK) and comprising a memory;
means for storing, at a first time, a personalization data ID (PDID) and associated personalization data (PD) in the memory;
means for sending, at a later time, the CID and the PDID to a security provider and receiving an activation value (AV) back from the security provider, the activation value AV being based, at least in part, on the CK and a personalization data key (PDK) associated with the PDID and the PD;
means for computing, in the device, a result, based, at least in part, on the CK and the activation value, the result being produced by applying a first function g to the CK and the AV, such that the result=g(CK, AV); and
means for storing the result in the memory,
wherein a second function ƒ is used to compute the value of AV, such that AV=ƒ(CK, PDK), and ƒ comprises an inverse function of function g, such that g(CK, ƒ(CK, PDK))=PDK,
thereby assigning the personalization data key PDK to the device.

19. The method according to claim 7 and wherein the cryptographic encryption function comprises AES encryption, and the cryptographic decryption function comprises AES decryption.

20. The method according to claim 7 and wherein the cryptographic encryption function comprises DES encryption, and the cryptographic decryption function comprises DES decryption.

21. The method according to claim 7 and wherein the cryptographic encryption function comprises 3DES encryption, and the cryptographic decryption function comprises 3DES decryption.

22. The method according to claim 7 and wherein the cryptographic encryption function comprises SERPENT encryption, and the cryptographic decryption function comprises SERPENT decryption.

23. The method according to claim 7 and wherein the cryptographic encryption function comprises IDEA encryption, and the cryptographic decryption function comprises IDEA decryption.
